(19) United States
(12) Patent Application Publication
(10) Pub. No.: US 2015/0328595 A1
(43) Pub. Date: Nov. 19, 2015

(54) POLYIMIDE MEMBRANE

(71) Applicant: EVONIK MEMBRANE EXTRACTION TECHNOLOGY LIMITED, London (GB)

(72) Inventors: Andrew Timothy BOAM, London (GB); Andreia Manuela Martins MIRANDA, Trondheim (NO); Andrew Guy LIVINGSTON, London (GB)

(21) Appl. No.: 14/644,492

(22) Filed: Mar. 11, 2015

Related U.S. Application Data
(63) Continuation of application No. 13/377,200, filed on May 17, 2012, now abandoned.

(30) Foreign Application Priority Data
Jun. 10, 2009 (GB) 0909967.2

(51) Int. Cl. B01D 71/64; B01D 69/10; B01D 61/28

(52) U.S. Cl. CPC B01D 71/64; B01D 61/28; B01D 69/10; B01D 2325/02

(57) ABSTRACT

A high mass transfer membrane for use in membrane phase contactors to extract a solute from an aqueous phase to a solvent phase and their method of preparation and use are disclosed. The membrane is formed from polyimide by phase inversion and may optionally be crosslinked to maintain stability even in the solvents from which the membranes were formed by phase phase inversion.

The present invention relates to a use of asymmetric polyimide membranes in phase contacting devices, for contacting two immiscible phases and extracting solute from a first phase to the second phase. The present invention relates to methods of extracting various substances from a first phase to a second phase using such asymmetric polyimide membranes.

The use of solvent extraction to selectively transport a chemical species from one phase to a second immiscible phase is a common industrial practice (Kirk-Othmer Encyclopaedia of Chemical Technology, 4^{th} ed., Wiley Blackwell). It is a process widely used throughout the chemical process industries to separate or purify chemical species.

To perform an extraction, the two liquid phases are contacted together and mixed thoroughly to generate interfacial area for mass transport of the extracted species to take place. During mixing, one of the phases, usually the one present at a lower volumetric fraction, forms discrete droplets within the second phase to generate a dispersion that provides high interfacial area for rapid mass transport. The key operating parameters for solvent extraction processes include the choice of solvent, extraction temperature, the flow or volume ratio of the two phases when they are contacted, in some cases the extraction pressure, the extractor type used, and the mixing intensity in the extractor (Perry's Chemical Engineers' Handbook, 6^{th} ed., D W Green and R H Perry, McGraw-Hill). These parameters must be optimised to obtain the target yield and/or purity of the extracted species. However, a further very important factor is how readily the two phases separate from each other once the extraction is complete to re-form two discrete continuous phases. In a substantial fraction of applications, this can be a problematic aspect of the process, and further, in applications where surface-active species are present that have the potential to stabilise the interface between the two phases (e.g. surfactants, proteins, biological polymers, etc.), the difficulty of the phase separation may preclude the use of solvent extraction due to the formation of stable dispersions/emulsions.

A number of approaches have been investigated and developed to try and overcome the limitations due to stable dispersion/emulsion formation, for example the installation of a secondary unit operation, to break the emulsion or dispersion after it is formed (see by way of example U.S. Pat. No. 3,865,732) or the direct use of surfactants to break the emulsion or dispersion (see by way of example U.S. Pat. No. 5,445,765).

However, an alternative approach is to prevent or minimise the formation of the emulsion or dispersion in the first place. One way of achieving this is through the addition of a further chemical compound to the system that disrupts the system's inherent ability to form emulsions/dispersions (e.g. “Causes of emulsion formation during solvent extraction of fermentation broths and its reduction by surfactants”, (2004), S. Lennie, P. J. Halling, and G. Bell, Biotech. Bioneng., 35(9), 948-950).

A further means of achieving this is through the use of low energy/low shear extraction systems, e.g. bucket contactors or columns, as these types of equipment do not impart a lot of energy into the extraction system, they do not tend to generate the small droplets (0.1 to 100 micron) that characterise more stable emulsions or dispersions. This is also a significant disadvantage of these contactors, as the fact that they do not generate fine droplets means that they do not generate as much surface area for mass transfer as higher energy/higher shear technologies and thus equipment tends to be larger and more expensive.

A further approach to prevent or minimise the formation of the emulsion or dispersions is to provide a fixed interfacial area for mass transfer, rather than generate the area through mixing of the fluids. In this approach, the fluid boundary of one liquid phase is located in or at the surface of a porous medium, which provides a fixed interface. The second liquid phase is then contacted with the porous medium containing the first liquid phase and the species to be extracted transports from the second liquid phase into the first liquid phase. As the two liquid phases do not mix together, emulsions/dispersions do not form. The porous medium for this type of process is typically a synthetic membrane material, such as a microfiltration or ultrafiltration membrane, and this approach is commonly referred to as membrane solvent extraction or membrane phase contacting (see for example CA1025368A, or “Hollow fiber solvent extraction of pharmaceutical products: A case study”, (1989), R. Prasad and K. K. Sirkar, J. Memb. Sci, 47(3), 235-259, or U.S. Pat. No. 5,714,072).

Despite the inherent advantages of the membrane phase contactor, one critical problem in their application is the elimination of phase breakthrough (see for example “Aqueous-organic membrane bioreactors. I. A guide to membrane selection”, 1991, A. M. Vaidya, G. Bell, and P. J. Halling, J. Memb. Sci., 71(1-2), 139-149, and “Aqueous-Organic Membrane Bioreactors 0.2. Breakthrough Pressure Measurement”, 1994, A. M. Vaidya, G. Bell, and P. J. Halling, J. Memb. Sci., 97, 13-26). This phenomenon occurs when the breakthrough pressure of the membrane, which is the pressure that must be applied to the membrane to force the non-impregnating liquid phase through the pores of the membrane, reduces. The breakthrough pressure is a function of both the pore size and the interfacial tension. According to the Laplace-Young equation, breakthrough pressure can be described by the following equation:

P_{b}=2σ Cos θ/r (Equation 1)

Where P_{b}=breakthrough pressure, σ=interfacial tension at the liquid-liquid interface, θ=contact angle between the wetting liquid and the membrane, and r=pore radius.

From this equation it is clear that the breakthrough pressure decreases as the pore radius increases, but importantly it also decreases as the interfacial tension decreases. Materials that can reduce surface tension include chemicals such as surfactants and proteins, and other materials such as dust. In nearly all industrial environments, there are materials present that can reduce the surface tension and thus decrease the breakthrough pressure. However, this is particularly problematic where membrane phase contactors are used with biological solutions, as biological polymers such as proteins are very potent surfactants that readily reduce the breakthrough pressure (“Surfactant-induces breakthrough effects during the operation of two-phase biocatalytic membrane reactors”, A. M. Vaidya, P. J. Halling, G. Bell (1994), Biotechnol. Bioeng., 44(6), 765-771). Membranes with smaller pores are often used to counteract the reduction in surface tension, but nanofiltration and tight ultrafiltration membranes often have low porosity and consequently their mass transfer rates are low compared to loose ultrafiltration and microfiltration membranes.

Work by Valadez-Blanco et al. has shown that organic solvent nanofiltration membranes prepared using Lenzing P84 polyimide polymer are suitable for use in a membrane phase contactor application involving whole cell biocatalysis (“A membrane bioreactor for biotransformations of hydrophobic molecules using organic solvent nanofiltration (OSN) membranes”, R. Valadez-Blanco, F. Castelo Ferreira, R. F. Jorge and A. G. Livingston (2008), J. Memb. Sci., 317(1-2), 50-64). The P84 polyimide polymer is a co-polyimide containing approximately 20% of polyimide of structure A below and approximately 80% of polyimide of structure B below:

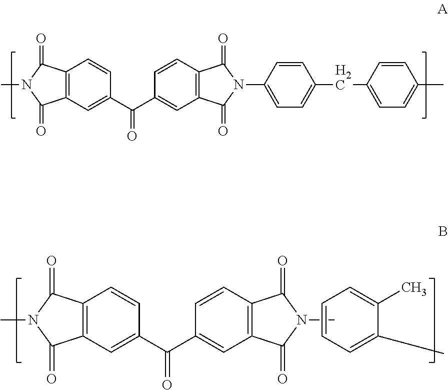

It was found in this work that these membranes did not suffer from phase breakthrough that occurs with looser membranes. However, the reduction in the level of phase breakthrough also leads to a concomitant reduction in the mass transfer rate. The measured mass transfer rates of the solute per unit membrane area were not found to be high enough to offer volumetric productivities higher than a direct-contact two-phase system and thus provide a viable industrial solution. It is therefore considered that an increase in the ‘tightness’ of the membrane will lead to a reduction in the mass transfer rate. This in turn reduces the overall viability of the membrane as a membrane for phase contacting. Unfortunately, a “tight” i.e. less porous membrane is needed to ensure good phase separation. Hence it is necessary to compromise between good mass transfer rates and good phase separation since the two properties seem to be mutually exclusive.

The present invention addresses the problem of the prior art in providing a membrane with a good mass transport rate and excellent phase separation characteristics. We have found a class of membranes based on Matrimid 5218 polyimide that allow the mass transfer rate of a given solute to be increased by a factor of at least 5 and more usually at least 10 times, whilst maintaining a stable interface for mass transfer. This result is surprising because the Matrimid 5218 polyimide membrane is even tighter than the Lenzing P84 membrane. In other words, the porous nature of the membrane of the present invention is reduced relative to Lenzing P84 membrane and yet the performance is significantly improved. It would be expected that the tighter Matrimid 5218 type membrane would have an even lower mass transfer rate than that of the Lenzing P84 membrane. This unexpected result addresses the key limitation of the prior art, i.e. low mass transfer rates.

It is therefore an aim of the present invention to provide a novel asymmetric polyimide membrane. It is also an aim of the present invention to provide a novel nanofiltration or ultrafiltration membrane. It is also an aim of the present invention to provide a nanofiltration or ultrafiltration membrane having an improved mass transfer rate as compared to other known nanofiltration or ultrafiltration membranes, when used in a membrane phase contactor. Yet another aim of the present invention is provide a nanofiltration or ultrafiltration membrane having a mass transfer rate of at least ten times the mass transfer rate of known nanofiltration membranes, when used in a membrane phase contactor. Another aim is to provide a nanofiltration or ultrafiltration membrane having good phase separation properties. Ideally, the membrane should have both good mass transfer and separation properties. Yet a further aim of the present invention is to provide a use of an asymmetric polyimide membrane in phase contacting to extract a solute from a first phase to second phase.

This invention provides a membrane that achieves one or more of the above aims.

Not meaning to be bound by theory, it is thought that the effect of increasing the mass transfer rate is dependent on the polymer used. It is thought that the increased hydrophobicity of the polyimide of the membrane contributes to the advantageous properties of the membranes of the present invention, such as the increased mass transfer rate in conjunction with good phase separation properties. This is so notwithstanding the apparently reduced porosity i.e. increased “tightness” of the Matrimid-type membranes of the invention. Thus, the diamine portion of the Matrimid 5218 polyimide is more hydrophobic than the diamine portion of the Lenzing P84 polyimide.

The Matrimid-type polymers used to form the membranes of the present invention are defined by the chemical formula (I) shown below and are all derived from Matrimid 5218. The present invention thus includes various modified Matrimid 5218 polyimide membranes defined below which allow substitution of a selection of hydrophobicity-modifying substituents on the polymer backbone. In certain applications the parent i.e. Matrimid 5218 polyimide itself is particularly effective as a membrane filter.

According to a first aspect, the present invention provides an asymmetric polyimide membrane comprising: (i) a porous supporting substrate, and (ii) a polyimide having a repeating unit of the formula (I):

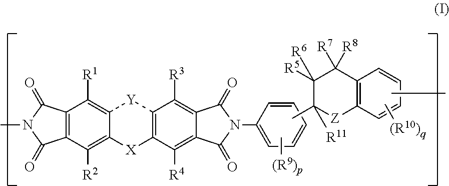

wherein:
each R¹, R², R³, R⁴, R⁵, R⁶, R⁷, R⁸ and R¹¹ is independently selected from the group comprising: H, C₁₋₃ alkyl, C₁₋₃ haloalkyl and halo;
X is selected from the group comprising: a bond and

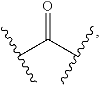 [SMILES: *C(*)=O]

Y is absent; or X and Y are each independently selected from the group comprising: a bond and

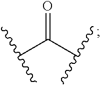 [SMILES: *C(*)=O]

or X and Y are each absent so as to form a fused aromatic structure of formula (II):

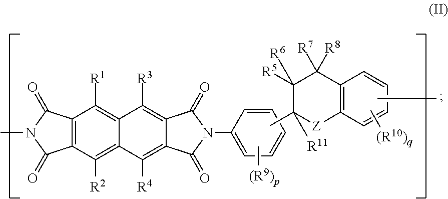

each R⁹, when present, is independently selected from the group comprising: C₁₋₃ alkyl, C₁₋₃ haloalkyl and halo;
each R¹⁰, when present, is independently selected from the group comprising: C₁₋₃ alkyl, C₁₋₃ haloalkyl and halo;
Z is selected from the group comprising: a bond and CR¹₂—;
p is 0-4; and
q is 0-3.

The polyimide of formula (I) is coated onto the porous supporting substrate. In effect, this forms a sheet or web of polyimide material which at least coats one surface of the porous supporting substrate. The coating may also penetrate the porous structure of the substrate to provide a “keying” effect and to prevent peeling or separation of the coating from the substrate.

In an embodiment, the polyimide has a molecular weight in the range 20,000 Daltons-1,000,000 Daltons. Preferably, the polyimide has a molecular weight in the range 50,000 Daltons-500,000 Daltons, and more preferably 70,000 Daltons-300,000 Daltons.

In an embodiment, the polyimide of the asymmetric polyimide membrane has the formula (III):

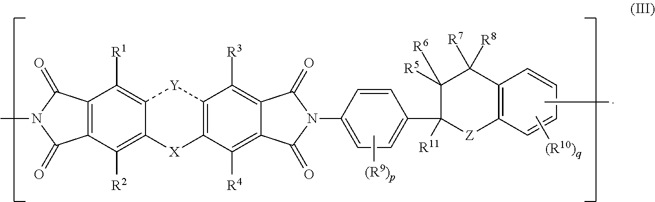

In an embodiment, R¹ is H.

In an embodiment, R² is H.

In an embodiment, R³ is H.

In an embodiment, R⁴ is H.

In an embodiment, X is C═O.

In an embodiment, Y is absent.

In an embodiment, p is 0.

In an embodiment, q is 0.

In an embodiment, R⁵ is H.

In an embodiment, R⁶ is H.

In an embodiment, R⁷ is Me.

In an embodiment, R⁸ is Me.

In an embodiment, R¹¹ is Me.

In an embodiment, Z is absent.

In an embodiment, each C₁₋₃ alkyl is independently Me, Et or Pr. Preferably, each C₁₋₃ alkyl is Me.

In an embodiment, each C₁₋₃ haloalkyl is independently a C₁₋₃ fluoroalkyl. Preferably, each C₁₋₃ haloalkyl is —CH₂F, —CHF₂ or —CF₃.

In an embodiment, halo means fluor, chloro, bromo and iodo. In an embodiment, each halo is independently selected from the group comprising: F and Cl. Preferably, each halo is independently F.

In one embodiment of the invention, the polyimide of the asymmetric polyimide membrane does not have the formula (IV):

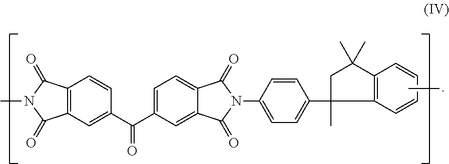

In an embodiment, the asymmetric polyimide membrane is an integrally skinned asymmetric polyimide membrane.

According to a second aspect, the present invention provides a use of an asymmetric polyimide membrane in the extraction of a dissolved solute from a first phase to second phase, the asymmetric polyimide membrane being a membrane as defined in the first aspect.

In embodiments, the polyimide of the asymmetric polyimide membrane used in the extraction of a dissolved solute from a first phase to second phase has the formula (I) defined above in the various preferred embodiments.

Equally, we have found that the Matrimid 5218 polymer itself is particularly good in terms of its phase separation and mass transfer performance for effecting separation of certain materials, and in particular biomaterials such as free fatty acids derived from natural lipids.

Thus in one embodiment, the polyimide of the asymmetric polyimide membrane used as a membrane filter has the formula (IV):

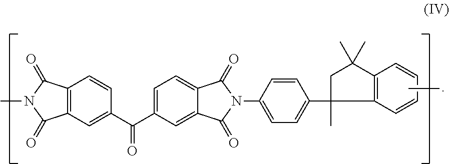

In another aspect, the present invention provides a method of removing a solute from an aqueous stream, the method comprising:
(i) contacting the aqueous stream comprising the solute with a first side of an asymmetric polyimide membrane as defined in the first aspect;
(ii) contacting a second side of the asymmetric polyimide membrane as defined in the first aspect with a non-aqueous stream.

In another aspect, the present invention provides a method of removing a solute from an organic stream, the method comprising:
(i) contacting the organic stream comprising the solute with a first side of an asymmetric polyimide membrane as defined in the first aspect;
(ii) contacting a second side of the asymmetric polyimide membrane as defined in the first aspect with an aqueous stream.

In an embodiment, the solute comprises a pollutant. In an embodiment, the solute comprises a catalyst. In an embodiment, the solute comprises free fatty acids. In an embodiment, the solute comprises the reaction product from a bio-catalytic reaction.

In an embodiment, the aqueous stream comprises a biological stream and the solute comprises free fatty acids derived from natural lipids. Thus the method of the present invention may involve selectively removing fatty acids from the aqueous phase into the organic phase whilst retaining large biological molecules in the aqueous phase. In an embodiment, the aqueous stream comprises a bio-catalyst (e.g. enzyme or whole-cell biocatalyst) and the reaction product from the bio-catalytic reaction (e.g. a chiral synthon such as the product from a chiral hydrogenation or chiral oxidation reaction). The reaction can therefore be used to separate the end products from a variety of biologically controlled reactions such as asymmetric hydrogenations and oxidations.

Thus, the present invention provides asymmetric polyimide membranes formed by phase inversion which are particularly suitable for use in membrane phase contactors.

The invention also provides a process for forming an integrally skinned asymmetric membrane for use in membrane phase contactors, comprising the steps of:
(a) preparing a dope solution comprising;
   (i) a polyimide polymer present in amounts of 5 to 30 wt % by weight of said dope solution, the polyimide polymer being as defined in the first aspect;
   (ii) a solvent system for said polyimide polymer which is water miscible;
   (iii) optionally a viscosity enhancer present in amounts less than 5 wt % of said dope solution;
   (iv) optionally a void suppressor present in amounts less than 10 wt % of said dope solution;
   (v) optionally a discrete organic or inorganic matrix dispersed in the dope solution in an amount less than 50 wt % of said dope solution;
(b) casting a film of said dope solution onto a porous supporting substrate to form a film cast;
(c) immersing the film cast on the substrate in a coagulating medium, after an optional evaporation period;
(d) optionally treating the cast film with a cross-linking agent to effect cross-linking;
(e) optionally treating the cast film with a wash bath or baths containing a conditioning agent;
(e) optionally drying the cast film.

Asymmetric membranes will be familiar to one skilled in this art and include an entity composed of a dense ultra-thin top “skin” layer over a thicker porous substructure of the same material, i.e. as being integrally skinned. Typically, when in flat sheet format the asymmetric membrane is supported on a suitable porous backing or support material.

The polyimide membranes of the invention can be produced from polyimide following methods described in the prior art, including U.S. Pat. No. 5,264,166 and GB2437519 patents. Polyimide polymers are synthesized from the polycondensation reaction of tetracarboxylic acid anhydrides with diamines. Tetracarboxylic acid anhydrides and diamines containing aromatic moieties are preferred for this invention. Non-limiting examples of these types of polyimides include P84 (HP Polymers, Austria) and Matrimid 5218 (Huntsman, Belgium).

Membranes in accordance with the invention can be made by dissolving the desired polyimide in a solvent together with optional viscosity enhancers, optional void suppressors, and optionally discrete particles of an immiscible matrix, to give a viscous, polymer dope solution. The polymer solution is spread on a porous support to form a film, optionally a portion of the solvent is evaporated, and the membrane film is quenched in a bath containing a nonsolvent for polyimide (i.e. a coagulating medium). This precipitates the polymer and forms an asymmetric membrane by the phase inversion process.

The polyimide polymer dope solution may be prepared by dissolving the polyimide polymer in one or a mixture of aqueous and/or organic solvents, including the following water-miscible solvents: N-methyl-2-pyrrolidone, N-ethyl-2-pyrrolidinone, N,N-dimethylpropionamide, N,N-dimethylacetamide, dimethylsulfoxide, tetrahydrofuran, N,N-dimethylformamide, 1,4 dioxane, γ-butyrolactone, water, alcohols, ketones and formamide.

The weight percent of the polyimide polymer in solution may range from 5% to 30% in the broadest sense, although a 15% to 25% range is preferable and a 20% to 25% range is even more preferred.

Additives such as viscosity enhancers may be present in amounts up to 10% by weight of the said polyimide polymer dope solution and these include polyvinyl pyrrolidones, polyethylene glycols and urethanes. Additives such as surfactants, which may influence the pore structure, may be used in amounts up to 5% of the weight of said polyimide polymer dope solution, for example Triton X-100 (available from Sigma-Aldrich UK Ltd. (octylphenoxy-polyethoxyethanol)).

Organic or inorganic matrices in the form of powdered solids may be present at amounts up to 50 wt % of the said polymer dope solution. Carbon molecular sieve matrices can be prepared by pyrolysis of any suitable material as described in U.S. Pat. No. 6,585,802.

Zeolites as described in U.S. Pat. No. 6,755,900 may also be used as an inorganic matrix. Metal oxides, such as titanium dioxide, zinc oxide and silicon dioxide may be used, for example the materials available from Degussa AG (Germany) under their Aerosol and AdNano trademarks. Mixed metal oxides such as mixtures of cerium, zirconium, and magnesium may be used. Preferred matrices will be particles less than 1.0 micron in diameter, preferably less than 0.1 microns in diameter, and preferably less than 0.01 microns in diameter. In some cases it may be advantageous to disperse the matrices in a separate solution from the dope solution, preferably an organic solvent solution, and then subsequently add this solution to the dope solution containing the polymer. In a preferred embodiment, crystals or nanoparticles of an inorganic matrix, for example zeolites or metal oxides, may be grown to a selected size in a separate solution from the dope solution, and this dispersion solution subsequently added to the dope solution containing the polymer. This separate solution may comprise water or an organic solvent with nanoparticles dispersed in the continuous liquid phase. In yet a further preferred embodiment, the solvent in which the matrix is dispersed may be volatile, and it may be removed from the dope solution prior to membrane casting by evaporation.

In one embodiment, once the polyimide polymer is dissolved in the solvent system described, and optional additives and organic or inorganic matrices are added into the dope solution so that the matrices are well dispersed, it can be cast onto a suitable porous support or substrate to produce flat sheet membranes (i.e. a film cast). The support can take the form of an inert porous material which does not hinder the passage of permeate through the membrane and does not react with the membrane material, the casting solution, the gelation bath solvent, or the solvents which the membrane will be permeating in use. Typical of such inert supports are metal mesh, sintered metal, porous ceramic, sintered glass, paper, porous nondissolved plastic, and woven or non-woven material. Preferably, the support material is a non-woven polymeric material, such as a polyester, polyethylene, polypropylene, polyolefin, polyetherether ketone (PEEK), polyphenyline sulphide (PPS), Ethylene-ChloroTriFluoroEthylene (Halar®ECTFE), or carbon fibre material.

Following the casting operation, an optional step may be carried out during which a portion of the solvent may be evaporated under conditions sufficient to produce a dense, ultra-thin, top “skin” layer on the polyimide membrane. Typical evaporation conditions adequate for this purpose include exposure to air for a duration of less than 100 seconds, preferably less than 30 seconds. In yet a further preferred embodiment, air is blown over the membrane surface at 15° C. to 25° C. for a duration of less than 30 seconds.

The coagulating or quenching medium may consist of water, alcohol, ketones or mixtures thereof, as well as additives such as surfactants, e.g. Triton X-100 (available from Sigma-Aldrich UK Ltd (octylphenoxy-polyethoxyethanol)). The conditions for effecting coagulation are well known to those skilled in the art.

The solvent used in the coagulating medium and the dope solution are different. However, it is important that the solvent for the dope solution is miscible in the coagulating medium.

The asymmetric polyimide membranes formed can be washed according to the following techniques. Typically a water-soluble organic compound such as low molecular weight alcohols and ketones including but not limited to methanol, ethanol, isopropanol, acetone, methylethyl ketone or mixtures thereof and blends with water can be used for removing the residual casting solvent (e.g. NMP) and other additives from the membrane. Alternatively the membrane may be washed with water. Removal of the residual casting solvent may require successive wash blends in a sequential solvent exchange process.

Suitable amine crosslinking agents for crosslinking the polyimide incorporate primary and/or secondary amines. Suitable amine crosslinking agents include those reported in WO 2006/009520 A1 and U.S. Pat. No. 4,981,497. The functionality of such materials encompasses mono-, di, tri-, tetra-, and polyamines. Examples of suitable amino-compositions include ammonia, hydrazine, aliphatic amines, aliphatic-aromatic amines and aromatic amines. Specific examples of aliphatic amines include diaminobutane, diaminopentane, diaminohexane, diaminoheptane, diaminooctane, diaminononane, diaminodecane, methylamine, ethylamine, propylamine, isopropylamine, butylamine, isobutylamine, cyclohexylamine, dimethylamine, diethylamine, dipropylamine, diisopropylamine, ethylene diamine, N,N′-dimethylethylene diamine, N,N′-diethylethylenediamine, diethylenetriamine, triethylenetetraamine, tetraethylene pentaamine, pentaethylenehexamine, polyethyleneimine, JEFFAMINE compositions (diamines having a polyether backbone derived from ethylene oxide), polyallylamine, polyvinylamine, 3-aminopropyldimethylethoxysilane, 3-aminopropyldiethoxysilane, N-methylaminopropyltrimethoxysilane, 3-aminopropyltriethoxysilane, N-methylaminopropyltrimethoxysilane, 3-aminopropyl terminated polydimethylsiloxanes, and the like. Specific examples of aliphatic aromatic amines include benzylamine, meta-xylylenediamine, para-xylylenediamine and the like. Specific examples of aromatic amines include aniline, aniline derivatives, phenylene diamines, methylene dianiline, oxydianiline and the like. The preferred amino compounds are aromatic compounds containing 2 or 3 amino groups and 6 to 30 carbon atoms, or aliphatic compounds containing 2 to 6 amino groups and 1 to 40 carbon atoms.

The crosslinking agent may be dissolved in a solvent to form a crosslinking solution. The solvent can be an organic solvent chosen from ketones, ethers, alcohols, or any solvent that dissolves the crosslinking agent. In a preferred embodiment, the solvent in the crosslinking solution will also swell the asymmetric membrane to allowing good penetration of the crosslinking agent into the membrane. In a preferred embodiment, the solvent is an alcohol, and in yet a further preferred embodiment the solvent is methanol or ethanol. The concentration of crosslinking agent in the crosslinking solution can be adjusted with respect to the quantity of polyimide asymmetric membrane to be added per volume of solution, in order to control the extent of crosslinking that takes place, so that the ratio between amine groups in the crosslinking solution and imide groups in the membrane is in the range 0.0.01 to 10, and yet more preferably 0.1 to 5.

The time for crosslinking can be varied between 0.5 and 120 hours, more preferably between 1 and 30 hours, yet more preferably between 3 and 60 hours. The temperature of the crosslinking can be varied between 0 and the boiling point of the solvent, preferably between 0° C. and 60° C., yet more preferably between 10° C. and 40° C.

The asymmetric membrane is then conditioned by contacting the membrane with a conditioning agent dissolved in a solvent to impregnate the membrane. The conditioning agent is a low volatility organic liquid. The conditioning agent may be chosen from synthetic oils (e.g., polyolefinic oils, silicone oils, polyalphaolefinic oils, polyisobutylene oils, synthetic wax isomerate oils, ester oils and alkyl aromatic oils) and mineral oils, including solvent refined oils and hydroprocessed mineral oils and petroleum wax isomerate oils, vegetable fats and oils, higher alcohols such as decanol, dodecanol, heptadecanol, glycerols, glycols such as polypropylene glycols, polyethylene glycols, polyalkylene glycols. Suitable solvents for dissolving the conditioning agent include alcohols, ketones, aromatics, or hydrocarbons, or mixtures thereof. The use of a conditioning agent in accordance with the invention allows the membrane to maintain a high flux while exhibiting a high selectivity to permeate aromatics in the presence of non-aromatics. The conditioning agent also allows the membrane to be wetted with hydrocarbon solvents, to maintain a suitable pore structure in a dry state for permeation of aromatics, and to produce a flat sheet membrane with improved flexibility and handling characteristics.

Following treatment with the conditioning agent, the membrane is typically dried in air at ambient conditions to remove residual solvent.

The membranes described above can be used for membrane phase contactor operations where solute is extracted from an aqueous phase to an organic solvent phase. In particular, they offer solute mass transport rates at least 5 times higher than membranes made from other polyimide polymers. The membranes may offer solute mass transport rates at least 10 times higher than membranes made from other polyimide polymers. This means that much less membrane area is required for a given application which a major advantage over prior art asymmetric polyimide membranes.

By the term “membrane phase contactor” it is meant a membrane process in which the membrane provides a fixed interfacial area for mass transfer in a process, rather than mass transfer area being generated through the mixing of fluids. In a membrane phase contactor, the fluid boundary of one liquid phase is located in or at the surface of the membrane, providing a fixed interface. The second liquid phase is then contacted with the membrane containing the first liquid phase and the species to be extracted diffuses from the second liquid phase into the first liquid phase. Large molecules (>2,000 g·mol⁻¹) and polymeric species will be retained by the membrane and will not enter the first liquid phase. Thus, molecules <2,000 g·mol⁻¹ can be isolated from complex media, e.g. fermentation or biomass-derived solutions, without contamination from large molecular species. As the two liquid phases do not mix together, emulsions/dispersions do not form.

The term organic solvent will be well understood by the average skilled reader and includes organic liquids with molecular weight less than 300 Daltons. It is understood that the term solvent also includes a mixture of solvents.

By way of non-limiting example, solvents include aromatic hydrocarbons, alkanes, ketones, glycols, chlorinated solvents, esters, ethers, amines, nitriles, aldehydes, phenols, amides, carboxylic acids, alcohols, furans, and mixtures thereof.

By way of non-limiting example, specific examples of solvents include toluene, xylene, benzene, styrene, anisole, chlorobenzene, dichlorobenzene, chloroform, dichloromethane, dichloroethane, methyl acetate, ethyl acetate, butyl acetate, methyl ether ketone (MEK), methyl iso butyl ketone (MIBK), acetone, ethylene glycols, butanol, pentanol, hexanol, hexane, cyclohexane, dimethoxyethane, methyl tert butyl ether (MTBE), diethyl ether, adiponitrile, nitromethane, nitrobenzene, pyridine, carbon disulfide, tetrahydrofuran, methyltetrahydrofuran and mixtures thereof.

The term “solute” will be well understood by the average skilled reader and includes an organic molecule present in a liquid solution comprising water or organic solvent and at least one solute molecule such that the weight fraction of the solute in the liquid is less than the weight fraction of the solvent or water, and where the molecular weight of the solute is at least 20 g·mol⁻¹ higher than that of the solvent.

The membrane of the present invention can be configured in accordance with any of the designs known to those skilled in the art, such as spiral wound, plate and frame, shell and tube, and derivative designs thereof.

The present invention is illustrated by the following figures:

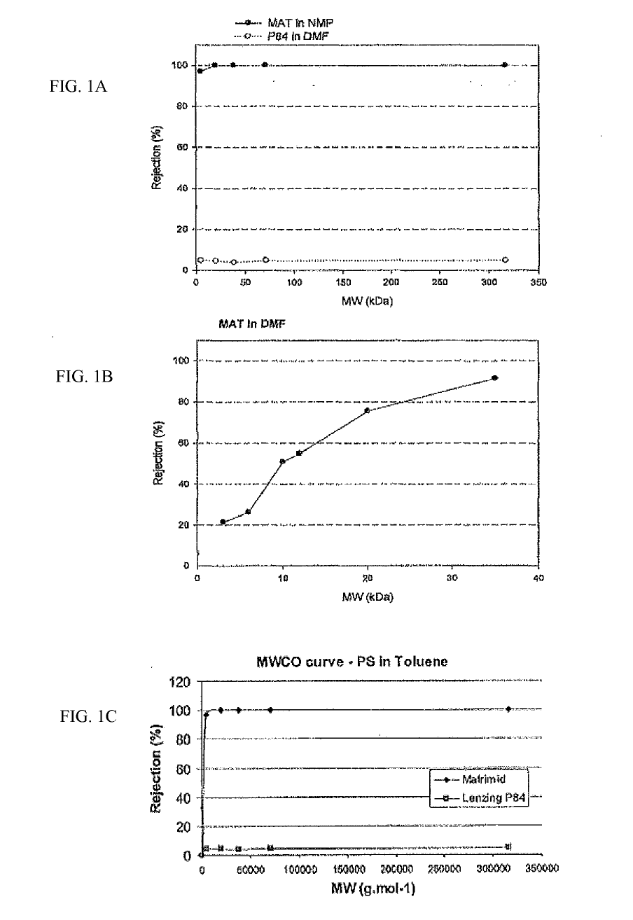

FIGS. 1A, 1B, and 1C: Molecular weight cut-off curves, MWCO, for each membrane in study obtained from the rejection tests with corresponding oligomers solution (PS1, PS2 or PEG, 1 g/L in toluene). FIG. 1A—MAT in NMP and P84 in DMF, PS (5-315 kDa); FIG. 1B—MAT in DMF, PEG (3-35 kDa). FIG. 1C shows molecular weight cut off curve, MWCO, for the P84 and Matrimid membranes using a solution of styrene oligomers (PS) in toluene.

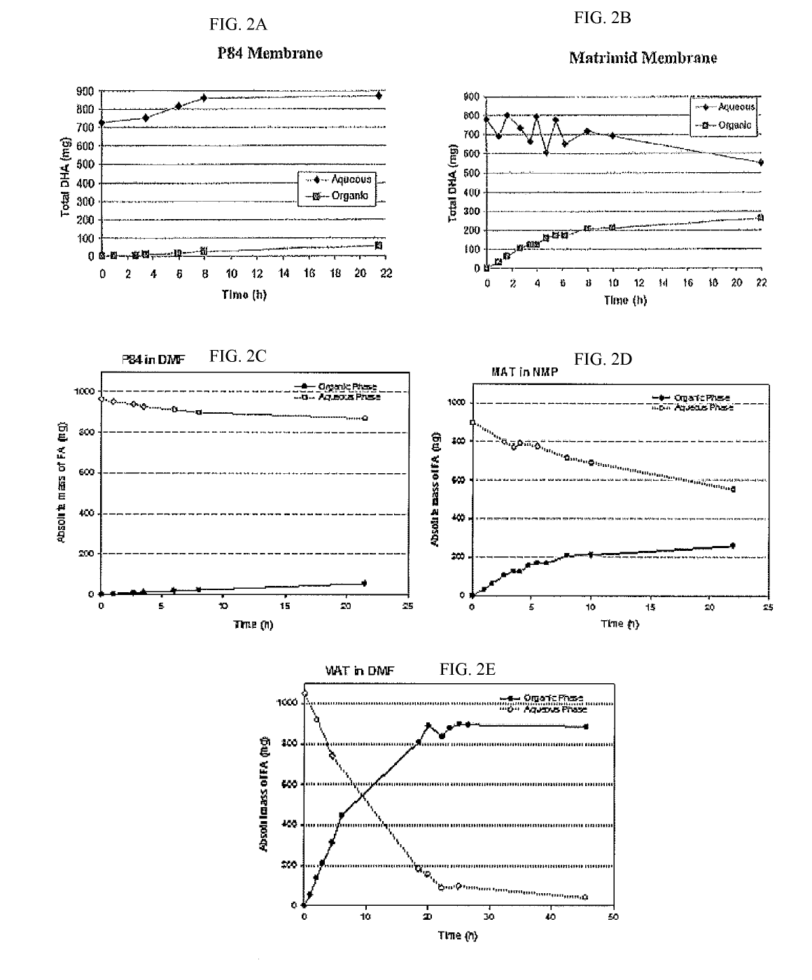

FIGS. 2A, 2B, 2C, 2D, and 2E:

FIGS. 2A and 2B: Evolution of total mass of DHA in both aqueous and organic phases over time for each membrane. FIGS. 2C, 2D and 2E presents the profile of the absolute mass of FA in aqueous and organic phases obtained throughout the experiment for each of the membranes in study.

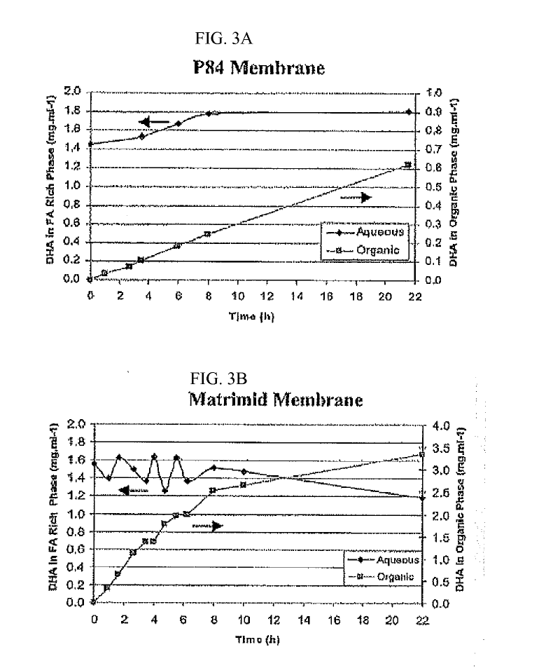

FIGS. 3A and 3B:

Evolution of DHA concentration in both aqueous and organic phases over time for each membrane (FIG. 3A shows P84 Membrane and FIG. 3B shows Matrimid Membrane).

The following examples illustrate the invention, but are not intended to be limiting on the scope of the invention.

### EXAMPLES

### Example 1

### Membrane Formation

Polyimide membranes (based on P84 polyimide (HP Polymers, Austria) or Matrimid® 5218 polyimide (Huntsman, Belgium)) were prepared according to the method described by Yoong Hsiang See-Toh et al. (2008). Detailed composition of the dope solutions from which the membranes were cast are shown in tables 1, 2 and 3.

TABLE 1
Dope solution composition for preparation of
Lenzing P84 polyimide membranes—“P84 in DMF”.

| Membrane Composition | | Weight (g) |
|---|---|---|
| P84 | 22% | 13.2 |
| Maleic Acid | 2% | 1.2 |
| DMF* | | 45.6 |
| Total (g) | | 60 |

*DMF—N,N-Dimethylformamide.

TABLE 2
Dope solution composition for preparation of Matrimid
5218 polyimide membranes—“MAT in NMP”.

| Membrane Composition | | Weight (g) |
|---|---|---|
| Matrimid 5218 | 26% | 15.6 |
| Maleic Acid | 1.5% | 0.9 |
| NMP** | | 43.5 |
| Total (g) | | 60 |

**NMP—N-methyl pyrrolidone.

TABLE 3
Dope solution composition for preparation of Matrimid
5218 polyimide membranes—“MAT in DMF”.

| Membrane Composition | | Weight (g) |
|---|---|---|
| MAT | 22% | 8.8 |
| Maleic Acid | [symbol] % | 0.8 |
| DMF* | | 30.4 |
| Total (g) | | 40 |

*DMF—N,N-Dimethylformamide. [symbol]
indicates data missing or illegible when filed

After the membrane was cast, it was impregnated with PEG400 (VWR, UK) before the membrane was dried.

The membranes were then characterised with respect to membrane flux performance and determination of the MWCO (molecular weight cut-off) curve (membrane rejection plotted as a function of molecular weight of the molecule being rejected) in a METcell dead-end filtration unit (Membrane Extraction Technology Ltd., UK).

The membrane flux was obtained using equation 2:

$${N}_{v} = \frac{V}{At} \qquad ( Equation 2 )$$

where V=volume permeated (L), A=membrane area (m²), and t=time over which the volume permeate (h).

Membrane rejection Rᵢ, is a common measure known by those skilled in the art for how much a solute is separated by a membrane and is defined as:

$${R}_{i} = ( 1 - \frac{{C}_{Pi}}{{C}_{Ri}} ) \times 100 \% ( 1 ) \qquad ( Equation 3 )$$

where C_{P,i}=concentration of solute i in the permeate, permeate being the liquid which has passed through the membrane, and C_{R,i}=concentration of solute i in the retentate, retentate being the liquid which has not passed through the membrane. A rejection value of 100% means that the solute is completely retained by the membrane and a rejection value of 0% means that the solute passes through the membrane at the same rate as the solvent (i.e. it is not retained at all by the membrane).

Membrane flux and MWCO measurements for P84 in DMF and MAT in NMP membranes were conducted at 5 bar filtration pressure for toluene and a solution consisting of a homologous series of styrene oligomers (10-300 kDa and labelled as “PS” in the following Tables and Figures) in toluene. For the characterisation of MWCO of MAT in DMF membrane, a series of PEG solutions (Polyethylene glycol, from 3 kDa up to 35 kDa) were tested separately.

The measured values of flux are presented in Table 4, and the MWCO curves (a plot of measured rejection of each oligomer versus the molecular weight of the specific oligomer) for the styrene oligomers solutions PS and PEG solutions, according to which solution was used in each case, are shown in FIGS. 1A, 1B, and 1C for all membranes in study.

TABLE 4
Flux values of the three membranes prepared and the
commercial membrane used in this and further examples.

| | | Flux (L.m⁻².h⁻¹) | | |
|---|---|---|---|---|
| | Pressure | | PS in | PEG in |
| Membrane | (bar) | Toluene | Toluene | Toluene |
| P84 in DMF | 5 | 1600 | 900 | — |
| MAT in NMP | 5 | 55 | 38 | — |
| MAT in DMF | 5 | 255 | | 23-134 ^{(*)} |

^{(*)} flux varied according to the molecular weight of PEG of each solution. As expected, flux was lower for bigger molecules.

From this data it is clear that under pressure filtration conditions, all membranes prepared show characteristics of ultrafiltration membranes, i.e. 90% rejection of styrene or polyethylene glycol oligomers is achieved at a molecular weight above 2,000 g·mol⁻¹ (2 kDa). The P84 membrane has a higher flux than both Matrimid membranes, and as expected it offers lower rejection of any given solute than the Matrimid membranes. The P84 membrane would be characterised as a “loose” ultrafiltration membrane (i.e. high MWCO, >>315 kDa) and the Matrimid membranes would be characterised as “tight” ultrafiltration membranes (i.e. low MWCO). However, a significant difference on the flux and MWCO can be observed between the two Matrimid membranes. MAT in NMP presented a lower molecular weight cut-off (˜5 kDa) and consequently lower flux (55 L·m⁻²·h⁻¹) than MAT in DMF (˜35 kDa and 255 L·m⁻²·h⁻¹). It is then possible to confirm that the combination of solvent and polymer plays an important rule on the membrane formation and consequently on the membrane flux and rejection performance.

### Example 2

### Membrane Performance in Membrane Phase Contactor

A complex solution containing a significant fraction of biological surfactants was chosen to demonstrate membrane performance, a fatty acid-rich solution was generated through the direct chemical hydrolysis of microalgae.

5 g of freeze-dried microalgae were dissolved in 150 ml 0.5M KOH in ethanol. Then the biomass suspension was incubated in a water bath at 60° C. for 2 hours. After cooling down to room temperature, 75 ml distilled water was added. Removal of unsaponifiables was not performed. The aqueous solution containing the salts of fatty acids was then acidified to pH 1.5 using a solution of 6M hydrochloric acid, in order to obtain the free fatty acids.

The fatty acid test solution was then used in a membrane phase contactor apparatus to asses membranes performance. The two liquid solutions used in the test were: (1) the fatty acids rich phase (pH ˜1.5) and (2) an organic solvent phase (hexane). The two phases were circulated continuously one on each side of the membrane cell using gear pumps at different flow rates. The fatty acids rich solution was circulated at 90 Uh and the hexane at 20 L/h. The three membranes characterised in Example 1 (P84 in DMF, MAT in NMP and MAT in DMF) were tested in order to find out how the membrane characteristics (polyimide and membrane cut off) affect the mass transport across the membrane. All experiments were conducted at room temperature and atmospheric pressure.

Samples were collected periodically throughout each experiment, up to 45 hours filtration time. For determination of the composition of a specific fatty acid (labelled as FA), samples were methylated and further analysed by gas chromatography using a DB-FFAP capillary column (30 m×0.25 mm inner diameter and 0.25 μm film thickness (J&W Scientific)). Quantification of fatty acids composition was carried out using known standard solutions (mixture ME 81 and standard C21:0; Larodan Fine Chemicals (Sweden)).

From plots in FIGS. 2C, 2D, and 2E, it is observed that the four membranes offer a completely different extraction performance. After the same operating period (22 hours), FA content in the organic phase when using the Matrimid membranes was at least five fold higher than for the P84 membrane in terms of absolute mass of FA. This is contrary to what would be expected from the pressure filtration results, which indicate that the P84 is a much looser, higher flux membrane than the Matrimid ones and consequently it would be expected that the P84 membrane would exhibit higher mass transfer coefficient and hence extraction would happen faster with the P84 membrane.

Values of the FA mass transfer coefficients (for transport from the aqueous feed phase to the hexane phase) calculated for each experiment are presented in Table 5. The initial concentrations of FA in the aqueous fatty acid rich phase (C_{FA,0}) for each experiment carried out are also shown in Table 5.

TABLE 5
Overall mass transfer coefficient, K, for FA mass transfer
through the membrane from the aqueous to organic phase.

| Membrane | C_{FA, 0} (mg/ml) | K (×10⁻⁷ m.s⁻¹) |
|---|---|---|
| P84 in DMF | 3.7 | 0.5 |
| MAT in NMP | 3.5 | 7.0 |
| MAT in DMF | 3.8 | 17.0 |

The overall mass transfer coefficient data in Table 5 indicates that when used as a phase contacting membrane, the Matrimid membranes has an overall mass transfer coefficient over ten times higher than the P84 membrane, which is a very unexpected result given that the P84 membrane has a much higher flux and higher MWCO membrane than the Matrimid membranes when used in a conventional, pressure-driven filtration. But the influence of the membrane cut-off on the mass transfer rates was noted between the two Matrimid membranes, MAT in DMF presented the best performance, over 80% of total fatty acids were transported through the membrane after 20 hours filtration. This surprising result indicates that the Matrimid membranes offer significantly superior and enhanced performance for application in this field.

1. An asymmetric polyimide membrane comprising: (i) a porous supporting substrate, and (ii) a polyamide having a repeating unit of the formula (I): 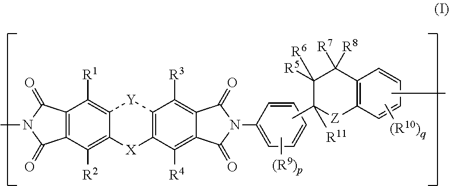
wherein: each R¹, R², R³, R⁴, R⁵, R⁶, R⁷, R⁸ and R¹¹ is independently selected from the group comprising: H, C₁₋₃ alkyl, C₁₋₃ haloalkyl and halo;
X is selected from the group comprising: a bond and 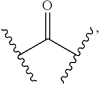 [SMILES: *C(*)=O]
and Y is absent; or X and Y are each independently selected from the group comprising: a bond and 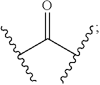 [SMILES: *C(*)=O]
or X and Y are each absent so as to form a fused aromatic structure of formula (II): 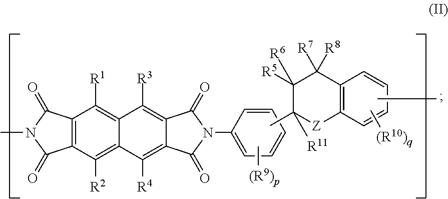
each R⁹, when present, is independently selected from the group comprising: C₁₋₃ alkyl, C₁₋₃ haloalkyl and halo;
each R¹⁰, when present, is independently selected from the group comprising:
C₁₋₃ alkyl, C₁₋₃ haloalkyl and halo;
Z is selected from the group comprising: a bond and CR¹₂—;
p is 0-4; and
q is 0-3.

2. The membrane according to claim 1, wherein the polyimide has the formula (III):

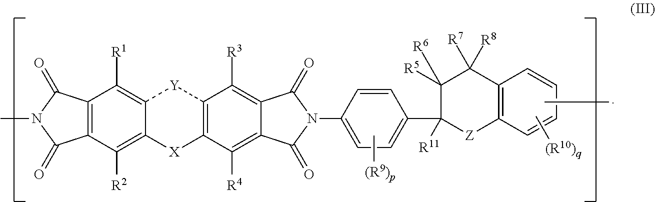

3. The membrane according to claim 1, wherein X is C═O and Y is absent.

4. The membrane according to claim 1, wherein Z is absent.

5. The membrane according to claim 1, wherein at least one of R¹, R², R³ and R⁴ is independently selected from the group comprising: —F, —CH₃, —CH₂F, —CF₂H and —CF₃, and the remaining are H.

6. The membrane according to claim 1, wherein at least one of R⁷, R⁸ and R¹¹ is independently selected from the group comprising: —CH₂F, —CF₂H and —CF₃, and the remaining are —CH₃.

7. The membrane according to claim 1, wherein at least one of R⁵ and R⁶ is independently selected from the group comprising: —F, —CH₃, —CH₂F, —CF₂H and —CF₃, and the remaining of R⁵ and R⁶ are H.

8. The membrane according to claim 1, wherein p is 1 or 2.

9. The membrane according to claim 8, wherein R⁹ is selected from the group comprising: —F₁—CH₃, —CH₂F, —CF₂H and —CF₃.

10. The membrane according to claim 1, wherein q is 1 or 2.

11. The membrane according to claim 10, wherein R¹⁰ is selected from the group comprising: —F, —CH₃, —CH₂F, —CF₂H and —CF₃.

12. A membrane according to claim 1, which contains crosslinks formed from the reaction of an organic crosslinking agent with the membrane polymer.

13. A membrane according to claim 1, wherein a discrete organic matrix is dispersed in the asymmetric membrane at amounts up to 50% by weight of said membrane.

14. A membrane according to claim 1, wherein a discrete inorganic matrix is dispersed in the asymmetric membrane at amounts up to 50% by weight of said membrane.

15. A membrane according to claim 13, wherein the average particle size of the discrete matrix is less than 0.1 micron.

16. A use of an asymmetric polyimide membrane according to claim 1, in the extraction of a dissolved solute from a first phase to a second phase.

17. A use according to claim 16 wherein the asymmetric polyimide membrane has a structure according to formula (IV):

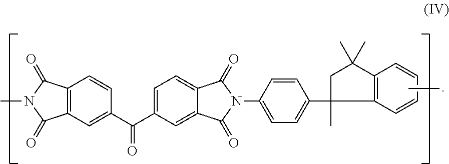

18. A use according to claim 16, wherein the dissolved solute has a molecular weight in the range of about 50 g mol⁻¹ to about 50,000 g mol⁻¹.

19. A use according to claim 16, wherein the solvent is an organic solvent and the membrane is stable thereto.

20. (canceled)

21. A membrane according to claim 14, wherein the average particle size of the discrete matrix is less than 0.1 micron.
